(19) United States
(12) Patent Application Publication
(10) Pub. No.: US 2022/0396017 A1
(43) Pub. Date: Dec. 15, 2022

(54) INJECTION MOLDED CARBON FIBER WEAVE TEXTURE AND METHOD OF APPLYING SAME

(71) Applicant: Plasman Holdings LP, Oldcastle (CA)

(72) Inventors: MATTHEW KLEIN, WINDSOR (CA); JEFF ST. PIERRE, WINDSOR (CA)

(73) Assignee: Plasman Holdings LP, Oldcastle (CA)

(21) Appl. No.: 17/836,548

(22) Filed: Jun. 9, 2022

Related U.S. Application Data
(60) Provisional application No. 63/208,539, filed on Jun. 9, 2021.

(51) Int. Cl. B29C 45/26; B29C 33/38

(52) U.S. Cl. CPC B29C 45/263; B29C 33/3842; B29C 2045/0079

(57) ABSTRACT

A simulated carbon fiber weave texture for use on component parts for automobiles and other vehicles and a method of applying same are provided. The component part can be prepared using plastic injection molded methods for varying types of plastic resins and applying different surface finishing processes, and a combination of texture etching practices can be used on the injection mold tool steel to simulate conventional carbon fiber appearance.

### RELATED APPLICATIONS

This application claims the benefit, and priority benefit, of U.S. Provisional Patent Application Ser. No. 63/208,539, filed Jun. 9, 2021, the disclosure and contents of which are incorporated by reference herein in their entirety.

### BACKGROUND

### Field of Invention

The presently disclosed subject matter relates generally to decorative texture components for automobiles and other vehicles, and methods for applying same.

### Description of the Related Art

For most exterior and interior decorative components for automobiles and other vehicles, the use of carbon fiber is merely for cosmetic reasons and does not serve any material functionality requirements. Conventional carbon fiber weave cosmetic parts are very expensive. The high cost of these cosmetic parts is what typically prevents the use of actual carbon fiber weave material for most automotive applications. In order to implement the carbon fiber aesthetics on decorative components, simulated or imitation carbon fiber can be used to help reduce the cost in comparison to real carbon fiber. Current market offerings for automotive uses on plastic injection parts provide a simulated product with a very flat, two-dimensional appearance that does not look similar enough to actual carbon fiber weave texture to be useful.

Improvements in this field are therefore desired.

### SUMMARY

In accordance with the presently disclosed subject matter, various illustrative embodiments of a simulated carbon fiber weave texture for use on component parts for automobiles and other vehicles and a method of applying same are described herein.

In certain illustrative embodiments, the presently disclosed subject matter also relates to a method of preparing an automotive component part with a simulated carbon fiber weave texture pattern, comprising: providing a plastic injection mold for manufacturing the automotive component part; developing a weave appearance for the texture pattern that is similar to a carbon fiber appearance, wherein the weave appearance comprises a horizontal repeating pattern, a vertical repeating pattern, and, at a base of the texture pattern, a horizontal strand pocket floor and a vertical strand pocket floor with a curved surface to simulate an over and under weave pattern; applying the texture pattern with the weave appearance as a repeating image to a surface of tool steel for the automotive component part using a 5-axis laser etching; preparing the automotive component part by injection molding with the plastic injection mold and one or more plastic resins using the tool steel with the texture pattern; and applying a surface finishing process to the automotive component part to better develop the final decorative appearance. The surface finishing process can include at least one of paint, chrome plating, physical vapor deposition, and paint over chrome.

### BRIEF DESCRIPTION OF THE DRAWINGS

A better understanding of the presently disclosed subject matter can be obtained when the following detailed description is considered in conjunction with the drawings and figures herein, wherein:

FIG. 1 is a high level overview of method steps in accordance with an illustrative embodiment of the presently disclosed subject matter;

FIG. 2 is a side-by-side comparison of different versions of carbon fiber textures implemented into tool steel in accordance with an illustrative embodiment of the presently disclosed subject matter;

FIG. 3 is a view of various images of texture depth for a texture pattern in accordance with illustrative embodiments of the presently disclosed subject matter;

FIG. 4 is a view of various images of texture depth for a texture pattern in accordance with illustrative embodiments of the presently disclosed subject matter;

FIG. 5 is an overall isometric view of a carbon fiber simulated texture with vertical and horizontal repeating patterns within the texture in accordance with an illustrative embodiment of the presently disclosed subject matter;

FIG. 6 is an isometric view of a carbon fiber simulated texture with vertical and horizontal repeating patterns within the texture with a particular light direction in accordance with an illustrative embodiment of the presently disclosed subject matter;

FIG. 7 is an isometric view of a carbon fiber simulated texture with vertical and horizontal repeating patterns within the texture with a particular light direction in accordance with an illustrative embodiment of the presently disclosed subject matter;

FIG. 8 is an isometric view of a carbon fiber simulated texture with vertical and horizontal repeating patterns within the texture with a particular light direction in accordance with an illustrative embodiment of the presently disclosed subject matter;

FIG. 9 is a plan view of a simulated carbon fiber texture comprised of different orientations of strands to simulate a woven fiber of a conventional carbon fiber weave pattern in accordance with an illustrative embodiment of the presently disclosed subject matter;

FIG. 10 is a plan view of a simulated carbon fiber texture comprised of different orientations of strands to simulate a woven fiber of a conventional carbon fiber weave pattern in accordance with an illustrative embodiment of the presently disclosed subject matter;

FIG. 11 is a plan view of a simulated carbon fiber texture comprised of different orientations of strands to simulate a woven fiber of a conventional carbon fiber weave pattern, and shows the texture depth, the vertical strand width, and relative spacing between the vertical strands before and after the top radius, in accordance with an illustrative embodiment of the presently disclosed subject matter;

FIG. 12 is a plan view of a simulated carbon fiber texture comprised of different orientations of strands to simulate a woven fiber of a conventional carbon fiber weave pattern, and shows the radii sizing at the top and periphery of the vertical strands, in accordance with an illustrative embodiment of the presently disclosed subject matter;

FIG. 13 is a plan view of a simulated carbon fiber texture comprised of different orientations of strands to simulate a woven fiber of a conventional carbon fiber weave pattern, and shows the depth and contour across the horizontal strand floor which is a curved geometric shape, in accordance with an illustrative embodiment of the presently disclosed subject matter;

FIG. 14 is an image of the varying depth adjustments of the texture image developed based on the geometric shape and contour of the part relative to the die direction of the tool, in accordance with an illustrative embodiment of the presently disclosed subject matter;

FIG. 15 is a comparison of plastic injection molded samples of the texture utilizing solid mold in colour (MIC) material in accordance with an illustrative embodiment of the presently disclosed subject matter; and

FIG. 16 is an image of a texture pattern for use in comparing texture detail capabilities between 3-axis laser etching, 5-axis laser etching, chemical etching, and machining/EDM processes in accordance with an illustrative embodiment of the presently disclosed subject matter.

While the presently disclosed subject matter will be described in connection with the preferred embodiment, it will be understood that it is not intended to limit the presently disclosed subject matter to that embodiment. On the contrary, it is intended to cover all alternatives, modifications, and equivalents, as may be included within the spirit and the scope of the presently disclosed subject matter as defined by the appended claims.

### DETAILED DESCRIPTION

The presently disclosed subject matter relates to a simulated carbon fiber weave texture for use on component parts for automobiles and other vehicles, and a method of applying same. In certain illustrative embodiments, the component part can be prepared using plastic injection molded methods for varying types of plastic resins and applying different surface finishing processes, and a combination of texture etching practices can be used on the injection mold tool steel to simulate conventional carbon fiber appearance.

In certain illustrative embodiments, the presently disclosed subject matter also relates to a method of preparing an automotive component part with a simulated carbon fiber weave texture pattern, comprising: providing a plastic injection mold for manufacturing the automotive component part; developing a weave appearance for the texture pattern that is similar to a carbon fiber appearance, wherein the weave appearance comprises a horizontal repeating pattern, a vertical repeating pattern, and, at a base of the texture pattern, a horizontal strand pocket floor and a vertical strand pocket floor with a curved surface to simulate an over and under weave pattern; applying the texture pattern with the weave appearance as a repeating image to a surface of tool steel for the automotive component part using a 5-axis laser etching; preparing the automotive component part by injection molding with the plastic injection mold and one or more plastic resins using the tool steel with the texture pattern; and applying a surface finishing process to the automotive component part to better develop the final decorative appearance. The surface finishing process can include at least one of paint, chrome plating, physical vapor deposition, and paint over chrome.

The presently disclosed subject matter seeks to resolve issues involving the high cost of real carbon fiber components, as well as provide an alternative to the simulated carbon fiber weave having a poor appearance that is currently available on the market today.

In certain illustrative embodiments, the presently disclosed subject matter results in a unique texture appearance that is an improvement over conventional injection molding with chemical etching, machining or electrical discharge machining (EDM) processes. Conventional chemical etching, machining or EDM processes cannot etch to varying depths across the texture pattern or repeat the fine details of the presently disclosed texture pattern. Attempts to repeat the fine details of the presently disclosed texture pattern with these other etching processes would incur significant costs and would be counterproductive to the cost savings from not using conventional carbon fiber weave parts.

In certain illustrative embodiments, the presently disclosed subject matter utilizes laser etching, which allows for etching fine details in the texture pattern and will be able to repeat effectively across the pattern when applying to tool steel. There are various types of laser etching practices, such as 3-axis and 5-axis etching. However, 3-axis laser etching does not have the capability to etch fine details with complex 3-dimensional geometric shapes and contours. Typically, 3-axis laser etching is limited to flat pattern texture and geometric shapes. By comparison, 5-axis laser etching allows for the etching of fine details in combination with complex 3-dimensional shape and contours. In certain illustrative embodiments, 5-axis laser etching is utilized for the creation and application of the textured appearance of the presently disclosed subject matter. The resulting product has increased distinction of image and a more realistic appearance.

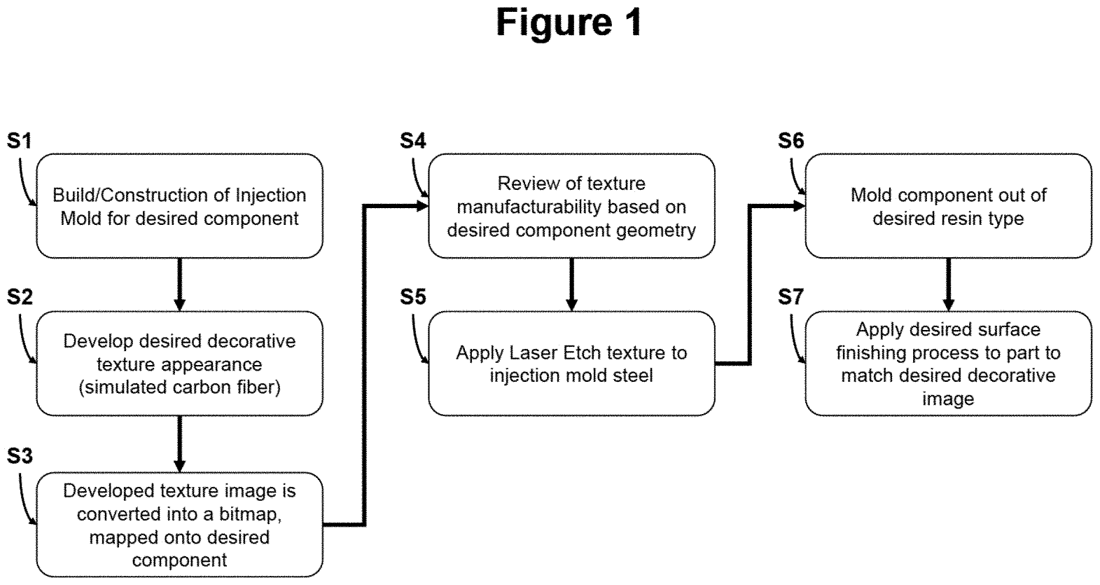

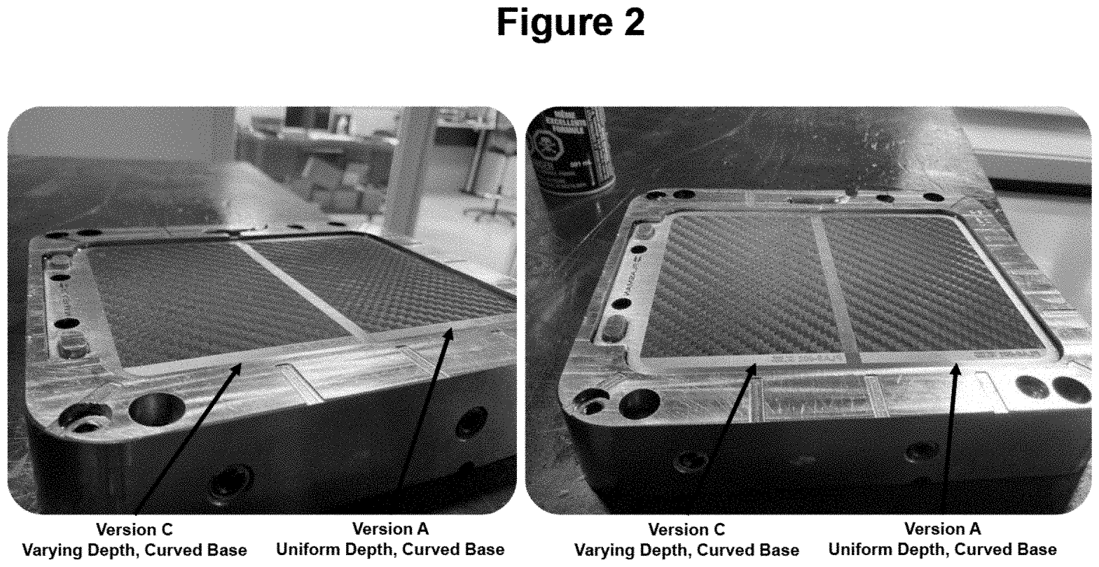

A high level overview of the method steps for an illustrative embodiment of the presently disclosed subject matter is provided in FIG. 1, with details of various features and illustrative embodiments shown in FIGS. 2-16. A key to the reference symbols in, or applicable to, FIGS. 1-16 is as follows:

1: vertical repeating pattern, 2: horizontal repeating pattern, 3: vertical strands, 4: vertical strand pocket floor, 5: horizontal strands, 6: horizontal strand pocket floor, 7: repeating pattern width, 8: repeating pattern length, 9: strand pocket width top before R-Tan, 10: strand thickness top before R-Tan, 11: strand pocket width bottom, 12: strand thickness bottom, 13: texture depth at strand end, 14: strand pocket periphery fillet/radius, 15: strand pocket top fillet/radius, 16: texture depth at strand midpoint, 17: strand floor curve. As used herein, the term “R-Tan” means the theoretical line or intersection point where sidewalls of the pocket meet the fillet/radius.

Referring now to FIG. 1, the method steps for a method for preparing and applying an injection molded carbon fiber weave texture pattern in an illustrative embodiment of the presently disclosed subject matter are provided. FIG. 1 illustrates an exemplary method with a plurality of sequential, non-sequential, or sequence independent “steps” as described herein. It should be noted that the method of FIG. 1 is exemplary and may be performed in different orders and/or sequences as dictated or described herein, and any alternative embodiments thereof. Numerous arrangements of the various “steps” can be utilized. In addition, not all “steps” described herein need be utilized in all embodiments. However, it should be noted that certain particular arrangements of “steps” for the methods described herein are materially distinguishable from and provide distinct advantages over previously known technologies.

In certain illustrative embodiments, the first step “S1” is to create an injection mold to manufacture the desired or intended component.

In certain illustrative embodiments, in step “S2”, the desired decorative pattern is developed, which is a new carbon fiber weave imitation pattern. Multiple embodiments of the pattern can be developed using 3D data sets. A sample laser grain is developed using an organic (non-repeating) pattern on a tooling insert to confirm development direction. After molding trials and paint trials with this texture, 3D data can be developed for a new texture with a geometric (repeating) pattern using laser etching that cannot not be achieved from standard chemical etching or machining processes. An illustrative embodiment is shown in FIG. 2, which is a side-by-side comparison of Version A and Version C of carbon fiber textures implemented into tool steel, where Version C has varying depth and a curved base whereas Version A has uniform depth and a curved base.

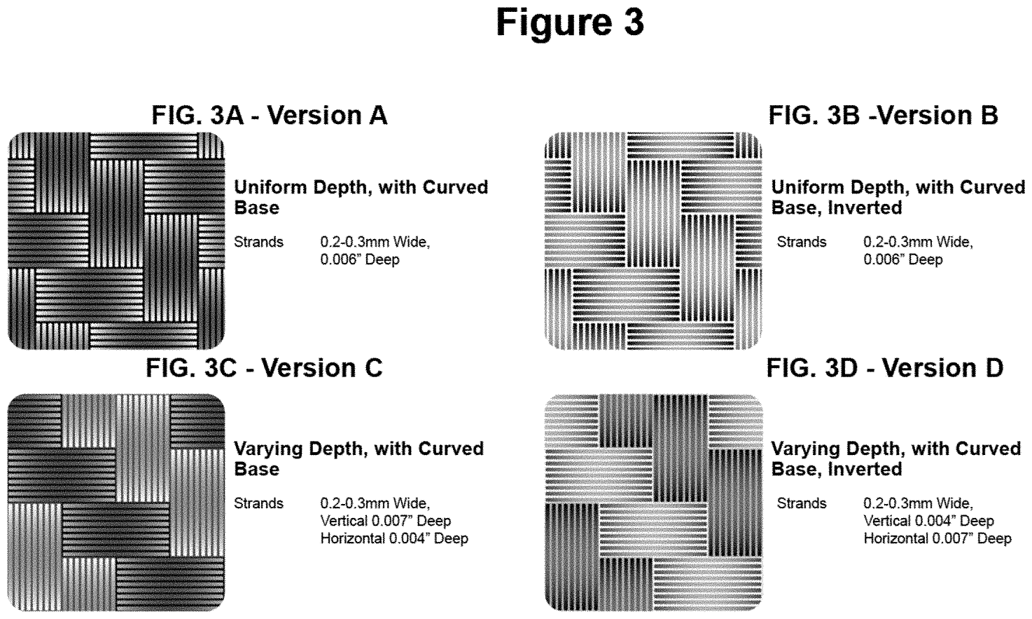

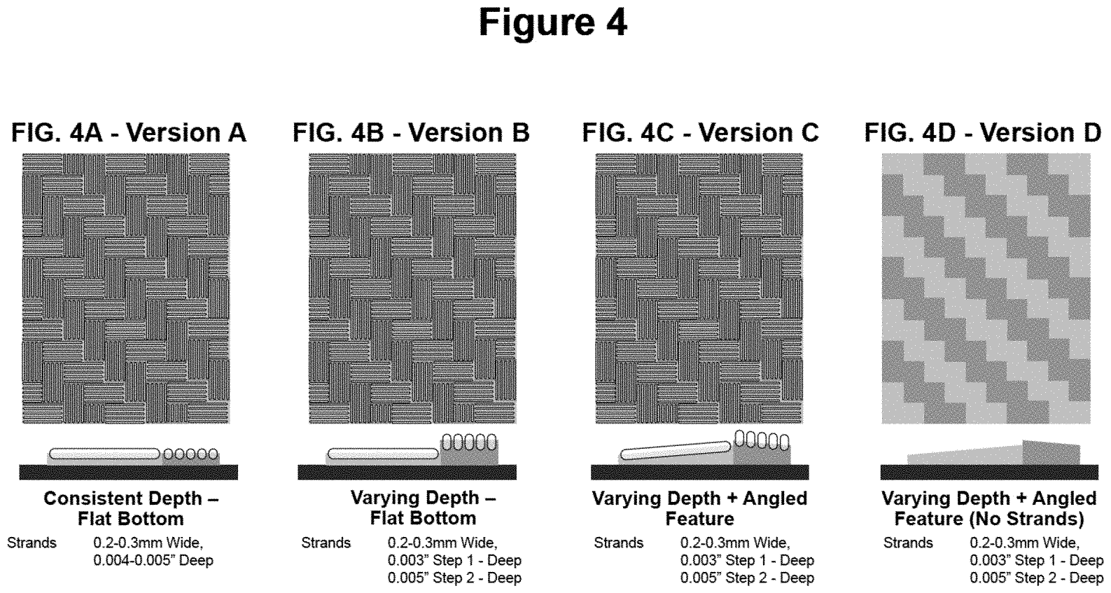

Examples of alternatives, modifications, and equivalents for the carbon fiber weave pattern can be referenced in FIG. 3 and FIG. 4. For example, FIG. 3 shows the detailed texture depth in a topical bitmap image development, showing how the texture depth changes across the pattern. It also shows different iterations, versions and embodiments of the texture pattern as FIG. 3A, FIG. 3B, FIG. 3C and FIG. 3D. FIG. 4 shows different iterations, versions and embodiments of the texture pattern, as well as detailing out the texture depths of each pattern, as FIG. 4A, FIG. 4B, FIG. 4C and FIG. 4D. Additional iterations, versions and embodiments could be applied to this texture pattern, for example, scaling (up or down) of the overall texture depth, length and or width, and changing the texture bottom face (increase or decrease radius, or any changed geometric shape).

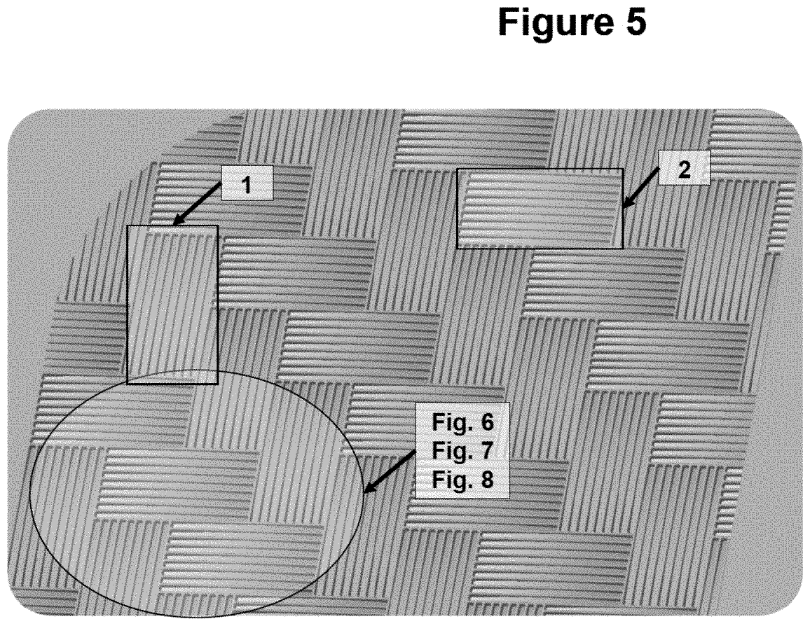

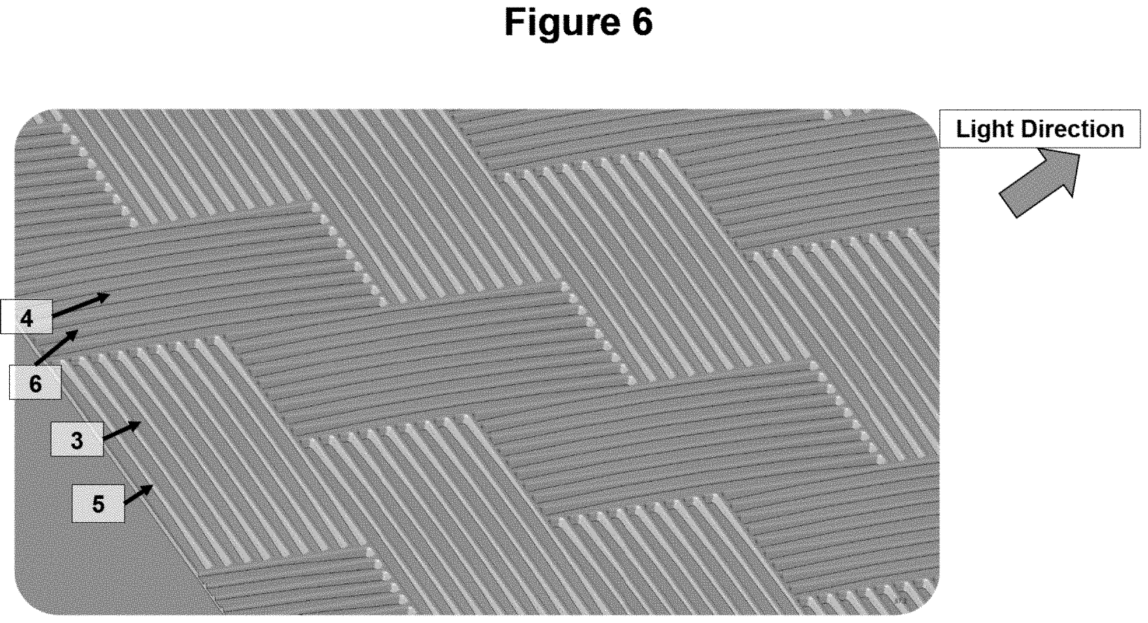

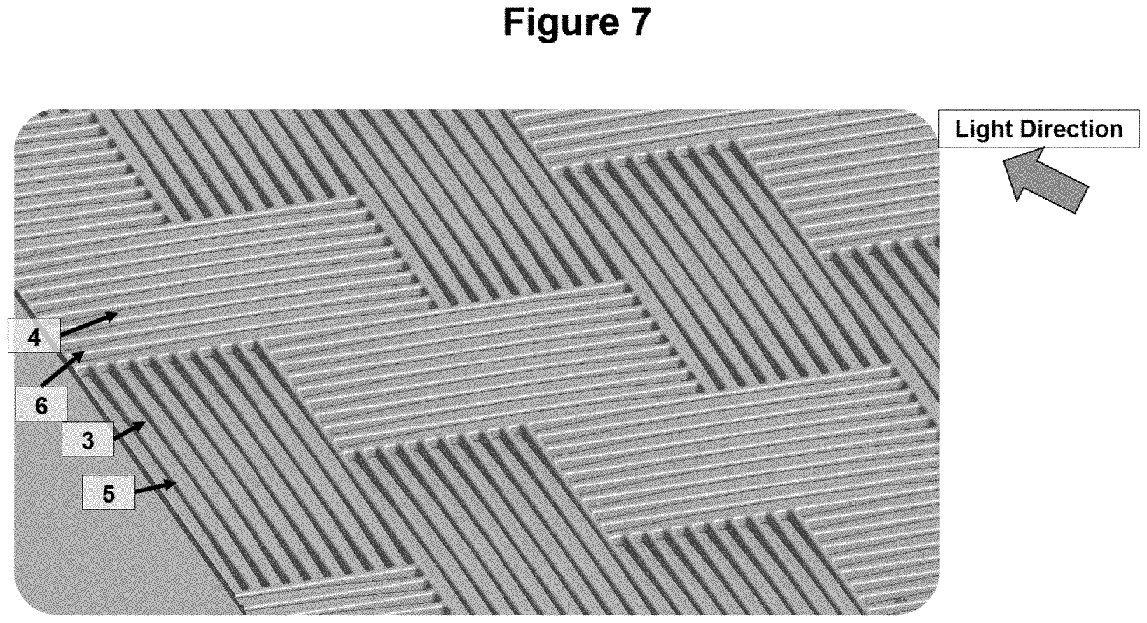

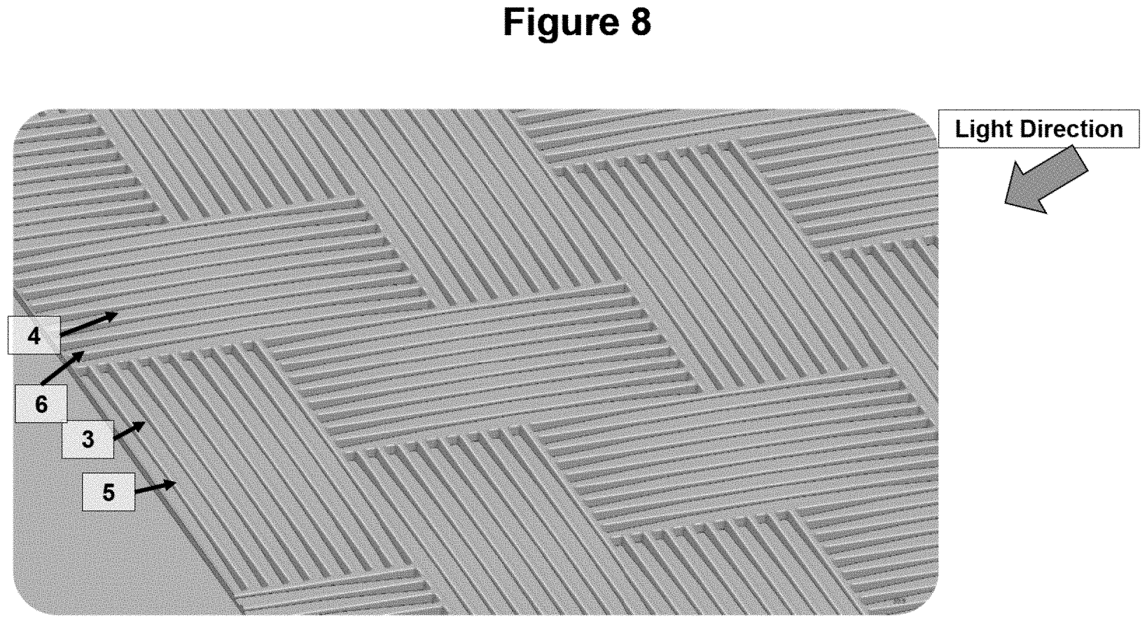

As shown in FIG. 5, FIG. 6, FIG. 7, and FIG. 8, in certain illustrative embodiments, the presently disclosed subject matter has developed vertical repeating patterns 1 and horizontal repeating patterns 2 which are highly defined features to reflect the light and truly give the appearance of conventional woven carbon fiber strands. These repeating patterns are set up to reflect light regardless of the angle from which a viewer sees the pattern. As the part is rotated, the light will reflect off of different features, mirroring the similar effect when looking at woven carbon fiber parts. FIG. 5 is an overall isometric view showing an example of the carbon fiber simulated texture. This image also shows the vertical and horizontal repeating patterns within the texture. The horizontal repeating pattern is set up with the sizing as the vertical repeating pattern but is rotated to 90° to be perpendicular to the horizontal repeating pattern. FIG. 5 also shows where the detailed isometric views of FIG. 6, FIG. 7 and FIG. 8 with reflecting light are referenced. FIG. 6 is an isometric view that is zoomed in, and shows an example of the carbon fiber simulated texture with a light source orientated at a general angle to illustrate how the light will reflect on the details of texture. FIG. 7 is the same isometric view of the texture from FIG. 6, with the light source at another general angle rotated about the part to illustrate how the light reflection will change based on the details of the texture. FIG. 8 is the same isometric view of the texture from FIG. 6 and FIG. 7, with the light source at yet another general angle rotated about the part to illustrate how the light reflection will change based on details of the texture.

In certain illustrative embodiments, the repeating patterns are made up of equidistant spaced vertical strands 3, and horizontal strands 5. Additional to these features, at the base of the texture pattern, the vertical strand pocket floor 4, and the horizontal strand pocket floor 6 can have a curved surface to simulate the “over” and “under” weave pattern of conventional carbon fiber. This is done so that when looking at where the vertical 1 and horizontal 2 repeating patterns intersect, they appear to be on top of each other.

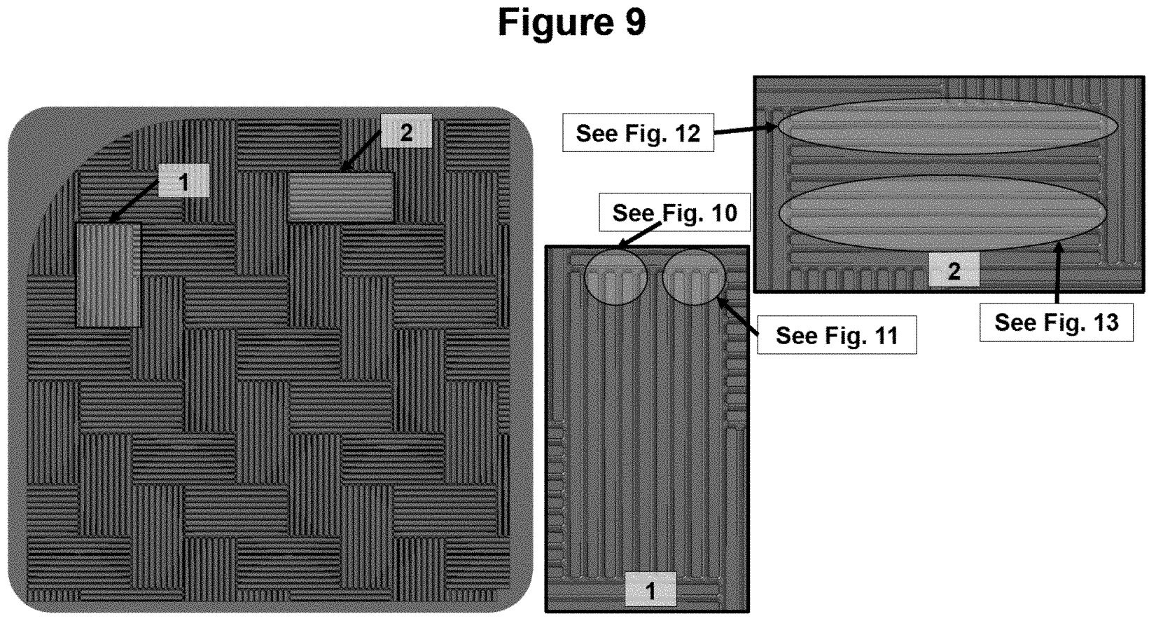

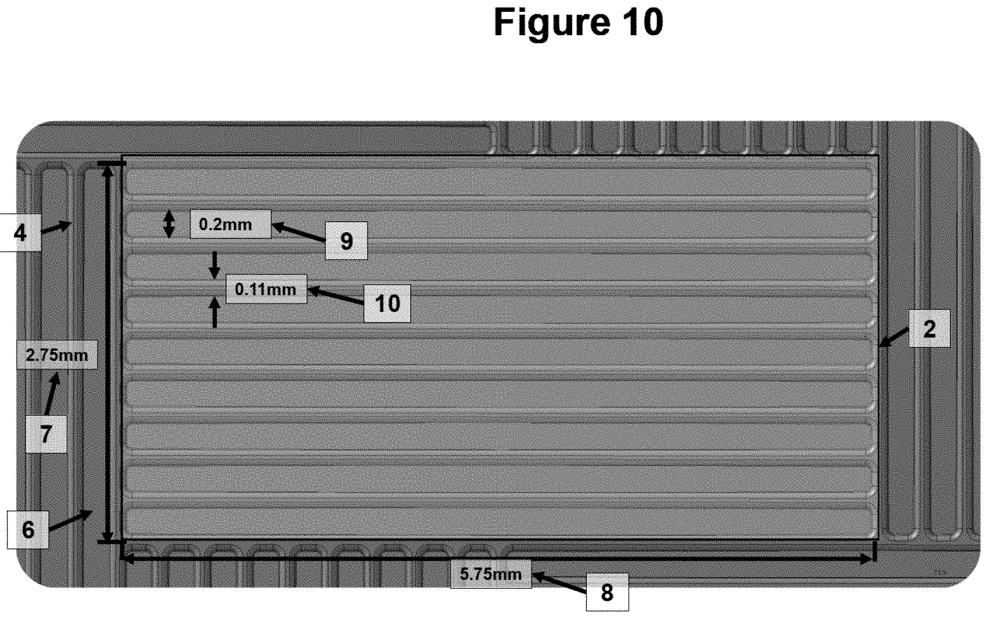

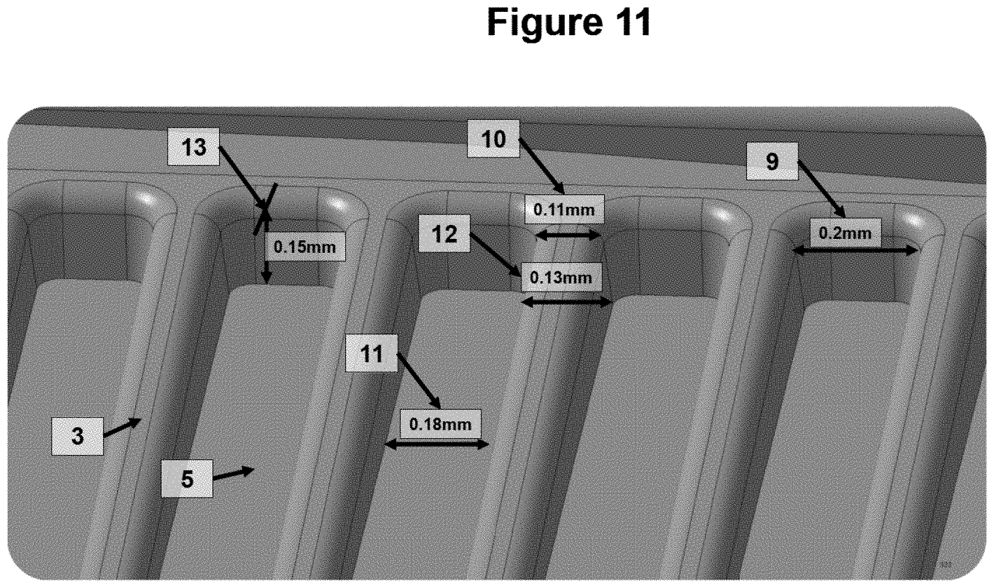

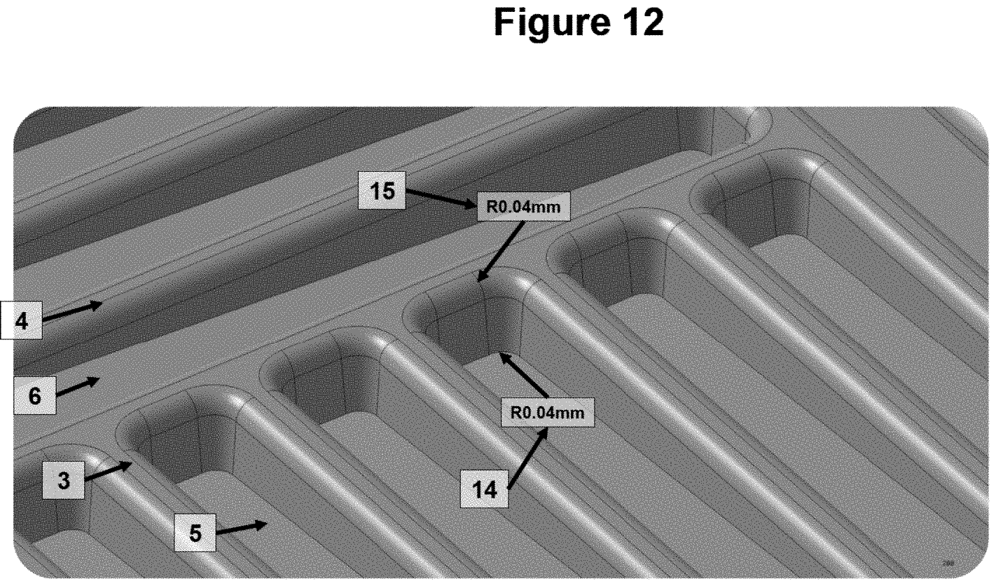

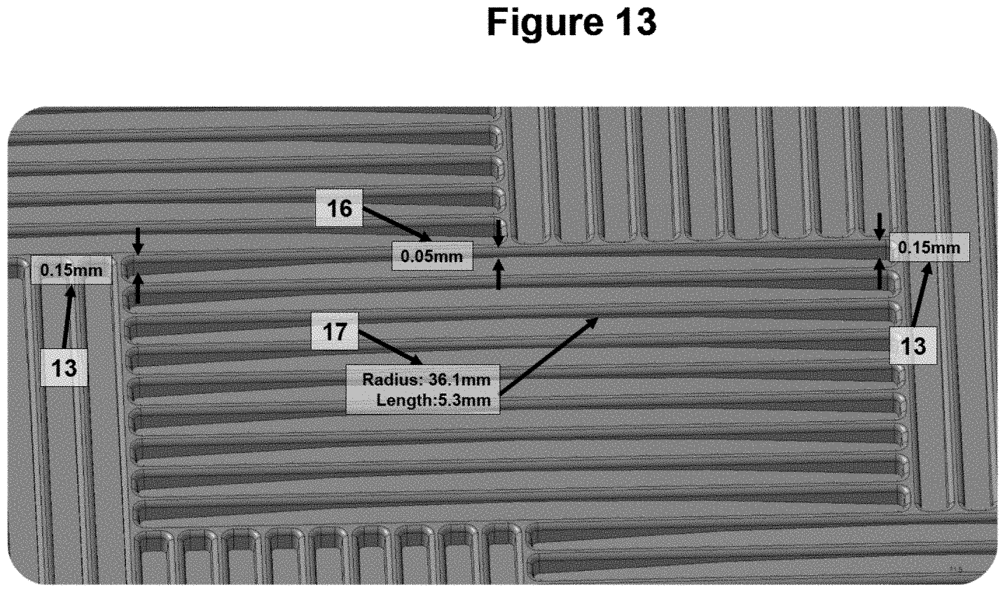

Additional details regarding these repeating patterns are shown in FIG. 9, FIG. 10, FIG. 11, FIG. 12, and FIG. 13. For example, FIG. 9 is a plan view showing how the simulated carbon fiber texture is comprised of different orientations of the strands. These strands are to simulate the woven fiber of a conventional carbon fiber weave pattern. This example also shows how FIG. 10, FIG. 11, FIG. 12, and FIG. 13 are referenced. FIG. 10 is a detailed plan view of the horizontal repeating pattern showing the overall length, width, and size as well as the strand spacing and width. The vertical repeating pattern is set up with the same sizing as the horizontal repeating pattern. FIG. 11 is a detailed isometric view of the texture to show the texture depth, the vertical strand width, and relative spacing between the vertical strands before and after the top radius. The horizontal strands are created with the same depth and relative spacing as the vertical strands. FIG. 12 is a detailed isometric view of the texture to show the radii sizing at the top and periphery of the vertical strands. The horizontal strands are created with the same radii sizing as the vertical strands. FIG. 13 is a detailed isometric view of the texture to show the depth and contour across the horizontal strand floor which is a curved geometric shape. The vertical strand floor is set up with the same depths and curvature.

In certain illustrative embodiments, in the next step “S3” the texture image is developed in a 3D “CAD” (computer-aided design) program to mock-up the intended visual representation of the texture shown in FIG. 5, FIG. 6, FIG. 7, and FIG. 8. The appropriate and preferred texture version is selected from the various embodiments shown in, e.g., FIG. 3A, FIG. 3B, FIG. 3C, and FIG. 3D. The preferred version is then developed into a texture topical bitmap file that details out texture geometry shape and relative depths on a micro level across the texture image. This bitmap image is developed to be used as a repeating image across the desired tool and then is used to process the etching of the texture onto tool steel as shown in the illustrative embodiments of FIG. 2. The laser etching machine can apply this texture 90° or normal to the part geometry surface in the tool steel.

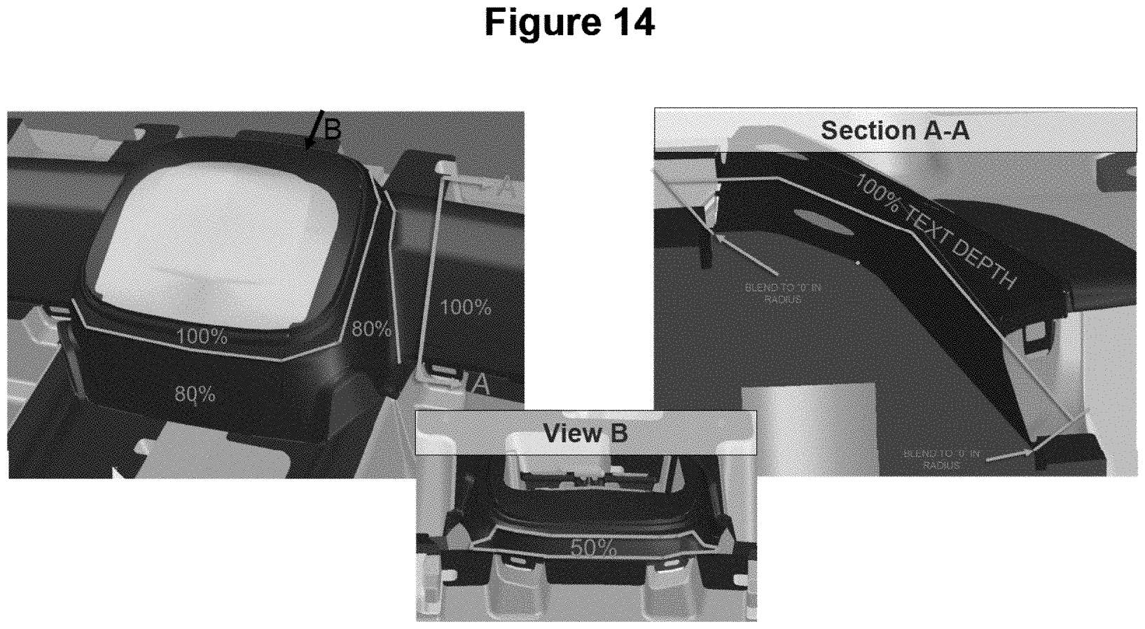

In certain illustrative embodiments, the next step “S4” is a texture manufacturability review. Due to the difference of how the laser applies the texture to the tool steel surface and the die-direction of the tool itself, there are multiple areas in which the texture can become die-locked (not feasibly manufactured). To avoid this problem, varying texture depths can be used across the tool steel specifically in areas that are die-locked as illustrated in FIG. 14. FIG. 14 is an example of the varying depth adjustments of the texture image developed based on the geometric shape and contour of the part relative to the die direction of the tool. The texture image remains the same, however, the texture depth is decreased to help mitigate any plastic part sticking in the plastic injection tool during the ejection process, and promote part release during ejection. For this reason, the presently disclosed subject matter is particularly applicable in the automotive context as compared to other industrial uses.

In certain illustrative embodiments, at the next step, “S5”, the etching of the texture is applied to the cavity or core side of the tool steel utilizing complex laser etch machining. This step is performed after the agreed upon lineup for the texture and the manufacturability review are completed. Upon completion of the laser etching being applied, the tool is then re-assembled and prepared for plastic injection molding trials.

In certain illustrative embodiments, the next step “S6” is to complete injection molding trials utilizing various plastic material resins to produce injection molded parts.

In certain illustrative embodiments, the next step “S7” is to apply various combinations of post molding or desired surface finishing processes (paint, chrome plating, physical vapor deposition, paint over chrome, etc.) to better develop the intended final decorative appearance that will be compared to real carbon fiber weave parts.

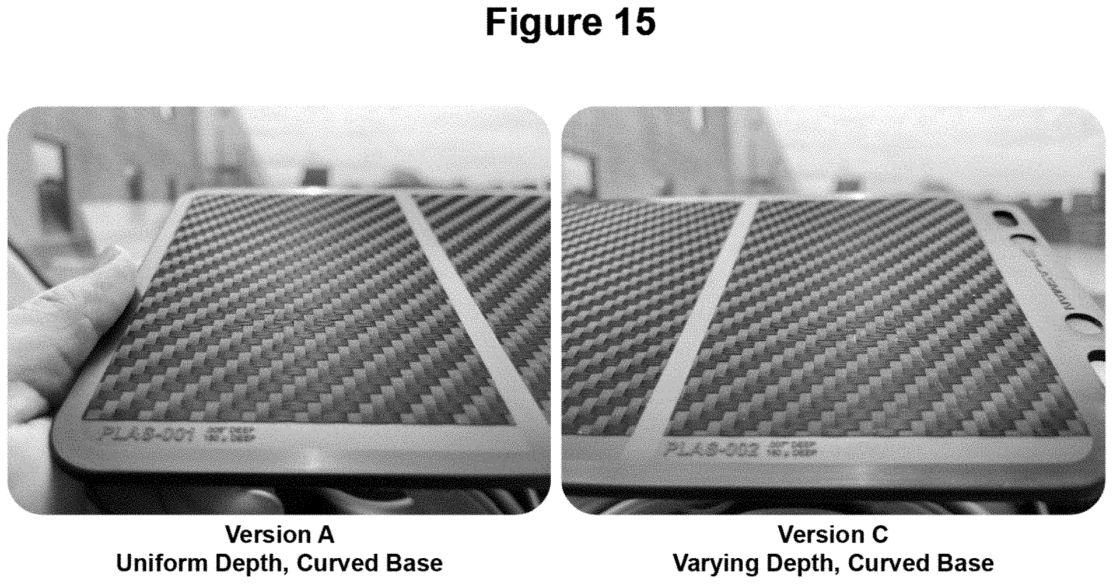

Plastic injection molded samples of the texture utilizing solid mold-in-color (MIC) material can be seen in FIG. 15, wherein Version A has a uniform depth and curved base while Version C has varying depth and a curved base.

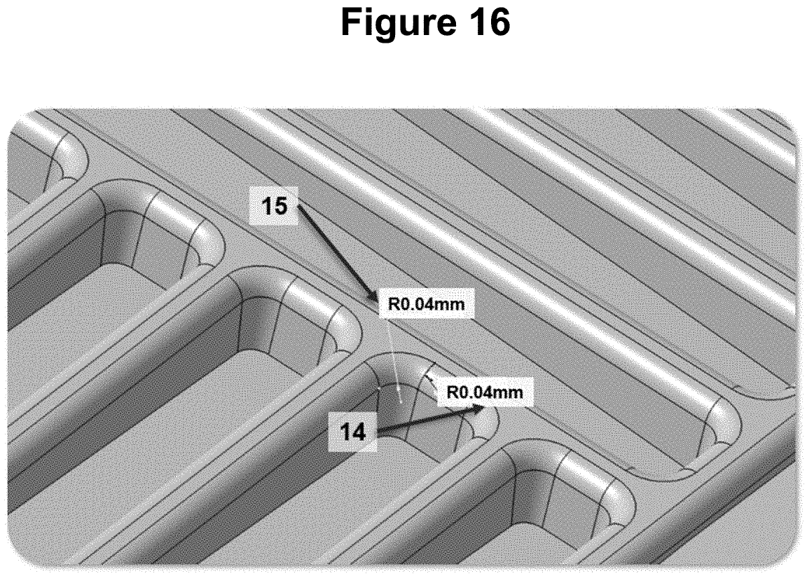

The presently disclosed subject matter has a number of advantages over existing technologies. For example, it is generally known in the art and/or industry to use chemical etching, machining and/or EDM processes to etch the desired pattern into the tool steel. However, the presently disclosed subject matter is distinct and distinguishable because it utilizes a laser etching process to allow for varying texture depths across the texture pattern and to repeat the fine details of the unique texture. In this regard, FIG. 16 is a comparison of texture detail capabilities between 3-axis laser etching, 5-axis laser etching, chemical etching, and machining/EDM processes. In a comparison of laser etch grain vs chemical etch, laser etch grain allows for varying depth of texture across the texture area, while chemical etching is typically at constant depth. In a comparison of laser etch grain vs. machining/EDM, geometry for laser etch grain is very detailed, having only R0.04 mm radius (R0.0015″ radius), while for machining/EDM, whether machined in steel or burned with EDM, the dimensions are highly detailed and are unable to be machined. When comparing 3-axis vs 5-axis laser etching, 3-axis laser cannot cut radius in a 3D geometric pattern and can only cut periphery radii, while 5-axis laser is required to be able to cut the 3D geometric radii and handle complex geometry.

Also, while it is generally known that the current market offerings only use etching a texture pattern to the injection mold for use with a solid mold in colour (MIC) plastic material without paint, the presently disclosed subject matter can additionally use solid MIC plastic material as well as clear resins combined with unique paint application to the injection molded part after molding to help improve the final texture appearance.

It is also generally known in the art through various manufacturing processes to laser etch onto substrates or components, termed “the part”, or to use a decorative film to apply the desired pattern. However, these prior processes do not produce a design with an acceptable final appearance that are comparable to real carbon fiber weave appearance. By comparison, the presently disclosed subject matter allows for varying texture depth as well as fine details on the tool and to the injection molded plastic part which provide the acceptable final appearance that rivals real carbon fiber weave. Also, the presently disclosed subject matter utilizes a tool made of steel or aluminum for injection molding, and not silicone molds for the manufacturing of the component.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C. As used herein, the term “A and/or B” means embodiments having element A alone, element B alone, or elements A and B taken together.

While the presently disclosed subject matter will be described in connection with the preferred embodiment, it will be understood that it is not intended to limit the presently disclosed subject matter to that embodiment. On the contrary, it is intended to cover all alternatives, modifications, and equivalents, as may be included within the spirit and the scope of the presently disclosed subject matter.

What is claimed is:

1. A method of preparing an automotive component part with a simulated carbon fiber weave texture pattern, comprising:
providing a plastic injection mold for manufacturing the automotive component part;
developing a weave appearance for the texture pattern that is similar to a carbon fiber appearance, wherein the weave appearance comprises a horizontal repeating pattern, a vertical repeating pattern, and, at a base of the texture pattern, a horizontal strand pocket floor and a vertical strand pocket floor with a curved surface to simulate an over and under weave pattern;
applying the texture pattern with the weave appearance as a repeating image to a surface of tool steel for the automotive component part using a 5-axis laser etching;
preparing the automotive component part by injection molding with the plastic injection mold and one or more plastic resins using using the tool steel with the applied texture pattern; and
applying a surface finishing process to the automotive component part.

2. The method of claim 1, wherein the surface finishing process comprises at least one of paint, chrome plating, physical vapor deposition, and paint over chrome.
